(19) United States
(12) Patent Application Publication
(10) Pub. No.: US 2010/0228786 A1
(43) Pub. Date: Sep. 9, 2010

(54) ASSESSMENT OF CORPORATE DATA ASSETS

(76) Inventor: Tibor Török, Budapest (HU)

Correspondence Address: LADAS & PARRY LLP, 26 WEST 61ST STREET, NEW YORK, NY, 10023, US

(21) Appl. No.: 12/400,001

(22) Filed: Mar. 9, 2009

(51) Int. Cl. G06F 17/30

(52) U.S. Cl. 707/802; 707/E17.071

(57) ABSTRACT

The present invention provides a data processing system and a method of assessing the data value of a data assets inventory which comprises:
a) preparing a data map on a computer database comprising inputting data types and data subtypes into said database, connecting a data storing location to the data subtypes and recording the data subtype occurrences in said database;
b) assigning a weighting to each data subtype occurrence in said database to provide a data assets inventory and recording the data assets inventory in said database;
c) preparing evaluation types on said database wherein the evaluation type has a calculation type attribute and wherein the evaluation type is either quantity independent or quantity dependent;
d) connecting at least one evaluation type to each data subtype with a reference value and recording the reference value in said database;
e) determining the data value of the data assets inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value for each data subtype occurrence.

### FIELD OF THE INVENTION

The present invention relates to a data processing system and a method for manipulating a data assets inventory to improve corporate information technology management.

### BACKGROUND OF THE INVENTION

Companies are constantly attempting to improve cost efficiency by applying new, innovative technologies and procedures. Information technology (IT) is one of the most important areas of technological development. However IT developments are risky, since the related costs are very difficult to control given that IT procedures and tools develop and become obsolete very quickly.

One of the most prominent IT phenomena is the disintegration of IT resources and the associated increase in costs. Disintegration occurs when a company employs an increasing number of IT tools and the interconnection of these IT tools becomes increasingly complicated.

Within company disintegration and operating costs usually increase at a similar rate until a decision is made that will result in the significant integration of the disintegrated corporate IT system. At this point a significant investment cost is incurred and a period of integration follows. However this is succeeded by a new stage of disintegration and typically this scenario repeats itself over a period of several years.

Consequently the present invention provides manageable information about the state of the disintegration of corporate IT system and the expected impact of modifications to the system to assist in the IT management.

### SUMMARY OF THE INVENTION

Accordingly, the present invention provides a method of assessing the data value of a data assets inventory which comprises:

a) preparing a data map on a computer database comprising inputting data types and data subtypes into said database, connecting a data storing location to the data subtypes and recording the data subtype occurrences in said database;

b) assigning a weighting to each data subtype occurrence in said database to provide a data assets inventory and recording the data assets inventory in said database;

c) preparing evaluation types on said database wherein the evaluation type has a calculation type attribute and wherein the evaluation type is either quantity independent or quantity dependent;

d) connecting at least one evaluation type to each data subtype with a reference value and recording the reference value in said database;

e) determining the data value of the data assets inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value for each data subtype occurrence.

Furthermore the present invention also provides a method of improving corporate information technology management comprising;

a) preparing a first data map on a computer database comprising inputting data types and data subtypes into said database, connecting a data storing location to the data subtypes and recording the data subtype occurrences in said database;

b) assigning a weighting to each data subtype occurrence in said database to provide a first data assets inventory and recording the first data assets inventory in said database;

c) preparing evaluation types on said database wherein the evaluation type has a calculation type attribute and wherein the evaluation type is either quantity independent or quantity dependent;

d) connecting at least one evaluation type to each data subtype with a reference value and recording the reference value in said database;

e) determining the data value of the first data asset inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value for each data subtype occurrence;

f) changing at least one of the data types, data subtypes, the reference value, the evaluation type, the calculation type, and the weighting in said database;

g) preparing a second data map on said database comprising inputting the data types and data subtypes into said database, connecting a data storing location to the data subtypes and recording the data subtype occurrences in said database.

h) assigning a weighting to each data subtype occurrence in said database to provide a second data assets inventory and recording the second data assets inventory in said database;

i) preparing evaluation types on said database wherein the evaluation type has a calculation type attribute and wherein the evaluation type is either quantity independent or quantity dependent;

j) connecting at least one evaluation type to each data subtype with a reference value and recording the reference value in said database;

k) determining the data value of the second data assets inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value of each data subtype occurrence;

l) comparing the total value of the first data assets inventory with the second data assets inventory to obtain a value differential, and;

m) using said value differential to improve corporate information technology management.

The present invention also provides a data processing system for producing a data assets inventory and calculating the data value comprising a computer processor means for processing data, a storage means for storing data on a storage medium, means for inputting and storing data types and data subtypes on the storage medium, means for assigning a data storing location to a data subtype and recording the data subtype occurrences to provide a data map, means for storing the data map on the storage medium, means for assigning a weighting to each data sub type occurrence to provide a data assets inventory, means for storing the data assets inventory on the storage medium, means for inputting evaluation types on the storage medium wherein the evaluation type has a calculation type attribute, means for connecting at least one evaluation type to each data subtype with a reference value, means for determining the data value of the data assets inventory and means for storing the data value on the storage medium.

Furthermore, the present invention also provides a data processing system for providing a value differential that can be used to improve corporate information technology management comprising a computer processor means for processing data, a storage means for storing data on a storage medium, means for inputting and storing data types and data subtypes on the storage medium, means for assigning a data storing location to a data subtype and recording the data subtype occurrences to provide a data map, means for storing the data map on the storage medium, means for assigning a weighting to each data subtype occurrence to provide a data assets inventory, means for storing the data assets inventory on the storage medium, means for inputting evaluation types on the storage medium wherein the evaluation type has a calculation type attribute, means for connecting at least one evaluation type to each data subtype with a reference value, means for determining a first data value of the data assets inventory, means for storing the first data value on the storage medium, means for modifying the data by changing at least one of the group consisting of data types, data subtypes, the reference value, the evaluation type, the calculation type, and the weighting, a means for determining a second data value of the data assets inventory, means for storing the second data value on the storage medium, a means for comparing the first data value and the second data value to obtain a value differential and a means for storing said value differential on the storage medium.

### BRIEF DESCRIPTION OF THE DRAWINGS

The features and advantages of the present invention will be more readily understood from a detailed description of the exemplary embodiments taken in conjunction with the following figures in which:

FIG. 1 shows the main functions of a data processing system according to an example embodiment;

FIGS. 2-7 show the procedure for maintenance of the data type, data subtype, model state, evaluation type, location, and reporting period maintenance;

FIGS. 8a and 8b show the data map version maintenance;

FIG. 9 shows the maintenance of reference values;

FIGS. 10a and 10b show the maintenance of the content of model versions;

FIGS. 11a, 11b, and 11c show the maintenance of data quantities;

FIG. 12 shows the calculation of the value of the data;

FIG. 13 shows the calculation of a data value at one location based on a given reference value; and

FIG. 14, which includes FIGS. 14-1 to 14-4, shows a data model of the data map, the data assets inventory, and their connection to the general ledger, and illustrates the function blocks and their relationship with each other.

### DETAILED DESCRIPTION OF THE INVENTION

The present invention is directed to the improvement of corporate IT cost efficiency through the mapping of the major types of data, financially assessing the data and using the derived information to manage the corporate IT system in accordance with the corporate strategy.

The present invention initially requires the preparation of a data map. The data map exhibits the types of data possessed by the company. The types of data are specified according to their main features and are defined locally by the user. Non limiting examples include Clients, Suppliers, Goods, Materials, Warehouses, Partners, Contracts, Financial Movements, Assets etc. These are nominated as data types. The data types typically encompass data subtypes e.g. Partner-Person, Partner-Supplier, Partner-Lawyer, ContractBSupply contract, Contract-Agent-contract, Financial movement B Advance payment, Financial movement-Bills, Financial Movement-Commission etc.

The location e.g. Subsystem1, Application2, machine2, safe No. 1, paper archives No. 3, database named ACorporate main@, database A, database C, database E, file sever named Abackup store@, Security Dept or any other location storing data is then assigned to the data subtype and the data subtype occurrence is recorded.

In a preferred embodiment of the present invention supplementary information such as the time of the establishment of the data subtype occurrence may be incorporated into the data map.

Subsequent to the formation of a data map the data map is expanded to provide a data assets inventory. The data assets inventory expands the data map by assigning a weighting to each data subtype occurrence. The weighting is typically between 0 and 1.

Furthermore evaluation types are established wherein the evaluation type has a calculation type attribute and is either quantity dependent or quantity independent. At least one evaluation type along with a reference value is then linked to each data subtype occurrence.

The evaluation type may be a monetary evaluation or could be an evaluation based upon other criteria such as the technical nature of the data or the level of security attached to the data. Typically the evaluation type is a monetary evaluation type.

The value of the data assets inventory is then determined wherein when the evaluation type is quantity dependent then the value is the sum of the product of the weighting, the reference value and the quantity at the data storing location for each data subtype occurrence or wherein when the evaluation type is quantity independent then the value is the sum of the product of the weighting and the reference value for each data subtype occurrence.

The weighting of the data type occurrence along with the evaluation type is determined by the corporate strategy and the three main mechanisms for assessing the data assets inventory are supporting rapid development, supporting integration and neutral assessment.

Supporting rapid development employs a linear function to assess the corporate data. The data subtype occurrence weighting is approximately 1. The evaluation type is quantity dependent. The results of this assessment method do not recognize the detrimental effects of IT disintegration and the more data subtypes occurrences equates to an increase in value of the data assets inventory.

Supporting integration is the opposite of supporting rapid development wherein the sum of the data subtype occurrence weighting totals a maximum of 1 when grouped by data types.

The evaluation type is quantity independent. The weighting is decreased as the number of the data subtype occurrences increases and this method is more supportive of IT integration. For example, if the ACustomers@ data type has only one subtype and one occurrence, a weighting of 1 means that the corporate IT is optimally integrated regarding the ACustomers@ data type. However if the ACustomers@ data type has two subtypes e.g. ACar Customers@ and AHifi Customers@, and three occurrences e.g. ACar Customers@ at Bigcity and Littletown, and AHifi Customers@ at Earth, a weighting of 0.2, 0.2, 0.2 with a sum of 0.6 indicates that the corporate IT system is disintegrating given that this exhibits a decrease in value of the data assets inventory.

Consequently if the aim of the strategy is powerful integration, the individual data subtype occurrences will receive a weighting that is roughly the inverse proportion of the number of occurrences. This ensures that when one type of data occurs once, the weight should be 1, for two occurrences it should be 0.33, 0.2 for three occurrences, and so forth. This ensures that when a new subsystem is employed which further divides the database of the company the value of the given data assets inventory will significantly decrease.

Neutral assessment is halfway between the previous methods. The sum of the data subtype occurrence weightings are close to 1 and the evaluation type is mostly quantity dependent. For example, if we have the previously mentioned 3 data subtype occurrences having a weighting of 0.3 and hence a sum of 0.9 this would result in a moderate decline in value.

The three main corporate IT strategies are rapid development, integration and sustenance. Rapid development is often selected by a new or changing corporation wherein the main objective is to implement new IT features in a minimal timeframe. Other aspects or effects have minimal impact on the IT decisions and this leads to IT disintegration. After some years of rapid development the corporate data disintegrates between the smaller systems and subsequently an integration strategy is employed. Finally a smoothly working corporation which doesn't want to change may employ a neutral assessment strategy.

Consequently the selection of the supporting rapid development type means that the assessment will favor the data type and subtype count and this assessment method serves well the rapid development corporate strategy, but produces false values for an integration strategy, showing high values while the corporate IT system disintegrates. Alternatively the supporting integration serves well the integration strategy, but not the sustenance and rapid development strategies. Finally the neutral assessment works well with the sustenance strategy.

However because generally disintegration is inevitable and the integration as a corporate task is an important one the most favorable assessment method is supporting integration.

In certain cases data may be afforded a specific value e.g. in the practice of legally trading in addresses, it is possible to specify the market value of the data of a potential customer accurately. However in other cases the data may have no recognized market value but may represent a significant value for the owner. In these circumstances certain criteria are taken into consideration, i.e., how much did it cost to produce the data? What would be the damage and the cost of restoration if the data were destroyed? What is the value created by the company by utilizing the data? What are the systems, organizations and individuals (within and outside the company) who use the data and what value do they create through using them?

These values are typically assigned by an expert group, with the participation of IT professionals, financial professionals and professionals who are familiar with the technical details of computing subsystem.

After a data assets inventory has been produced the total value is determined. This involves multiplying the weighting, and the quantity if the evaluation type is quantity dependent, or the multiplying the weighting, and the reference value, if the evaluation type is quantity independent, and then adding the resultant figures to obtain the total value of the data assets inventory.

When new plans for the corporate IT system are prepared which may involve the movement of data from one location to another, the creation of a new data subtype or the introduction of new computing tools, i.e., a new subsystem, a new data subtype occurrence is created and this will also effect the weighting of that data subtype occurrence. Consequently the data map and the data assets inventory are modified and by considering the relative values of the different data assets inventory in conjunction with the business strategy it can be determined whether the new plans are appropriate.

Hence before development related decisions are made, the impact of the available solutions on the data assets inventory can be qualified. Consequently the present invention provides a method that is simple and transparent and enables the synergy between the business strategy and modification of the corporate IT system to be enhanced.

In a preferred embodiment of the present invention the calculated data values may be added to the General Ledger and thus the audited data will exhibit an increase in the value of the company and provide a clearer picture about the situation of the company and its corporate IT system.

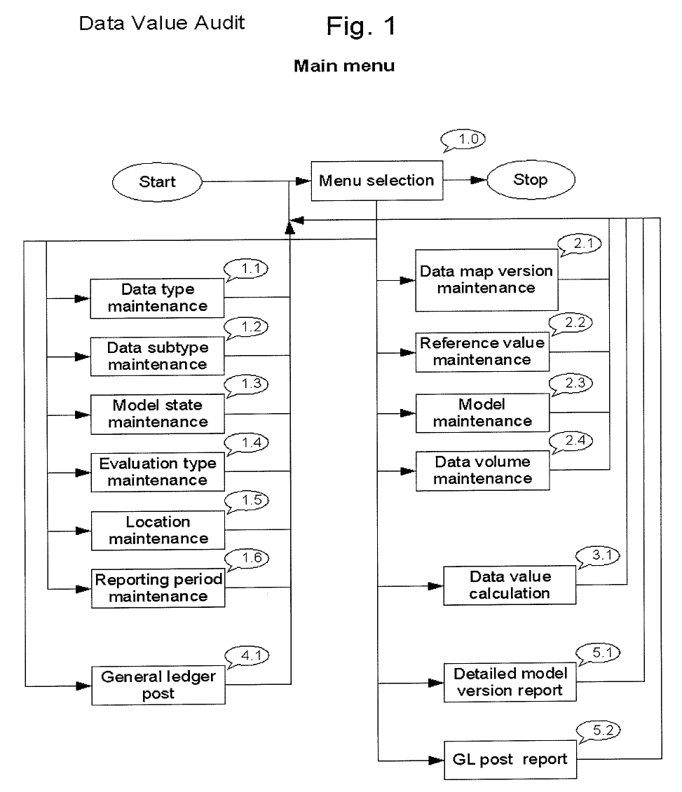

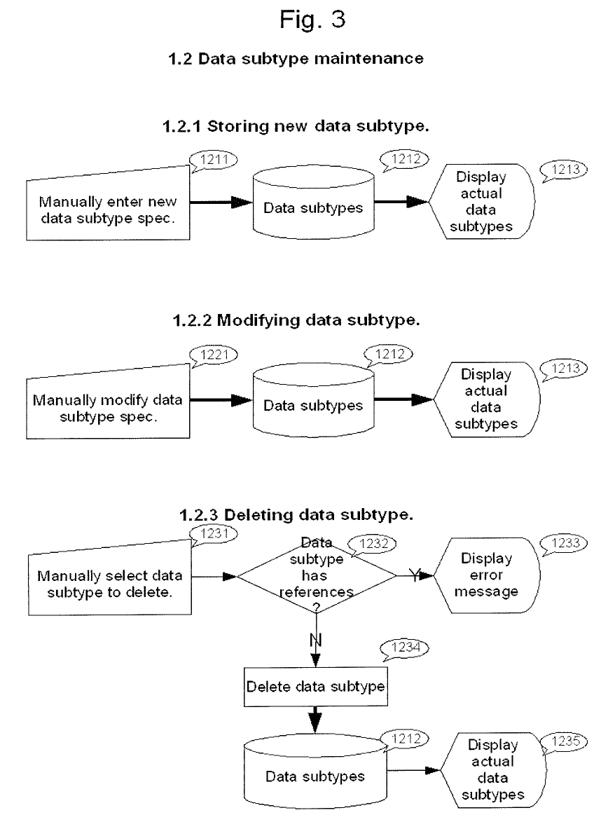

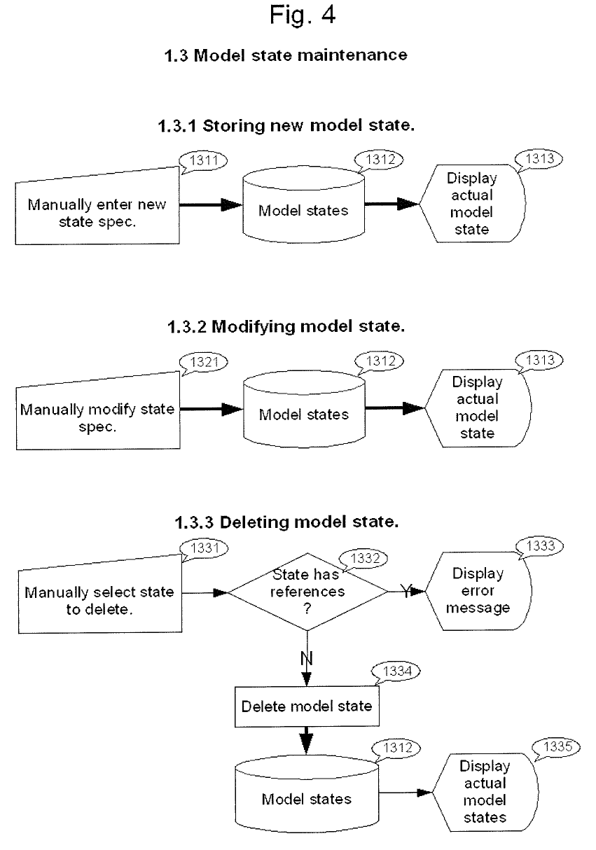

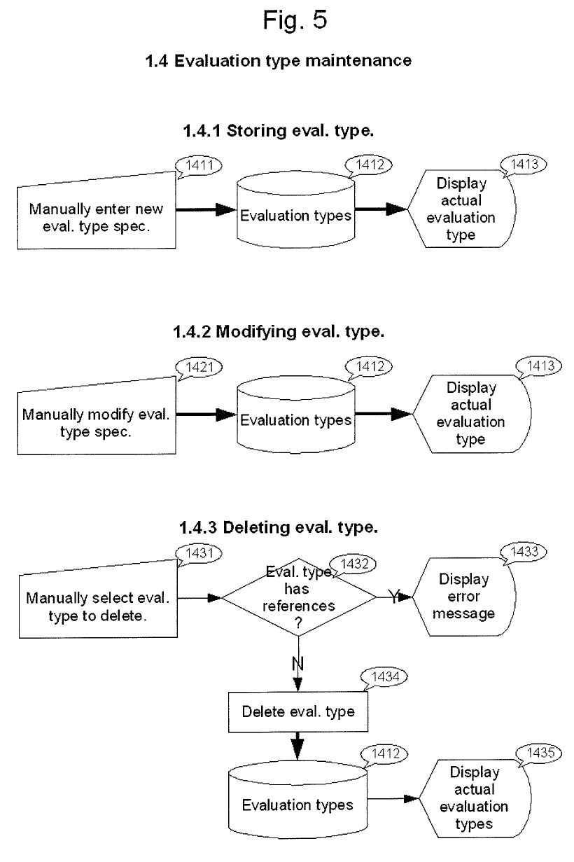

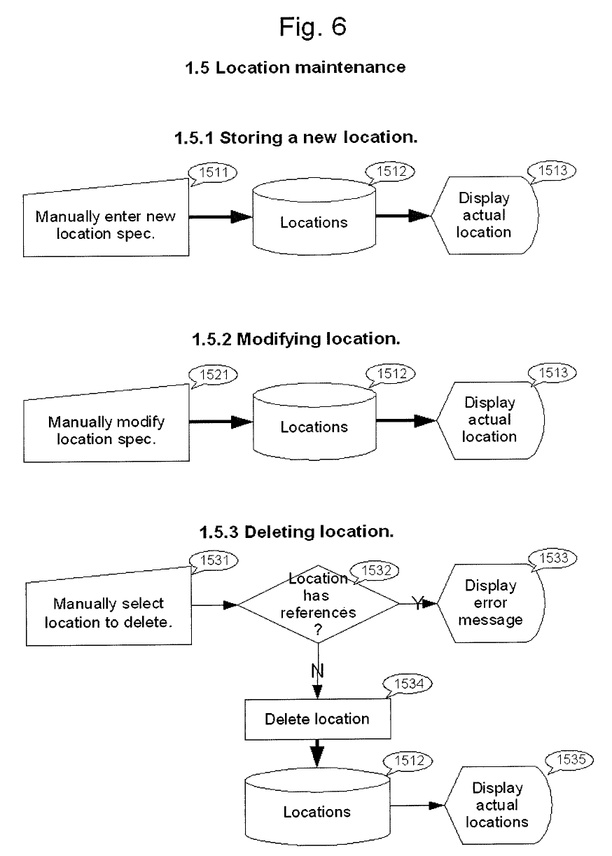

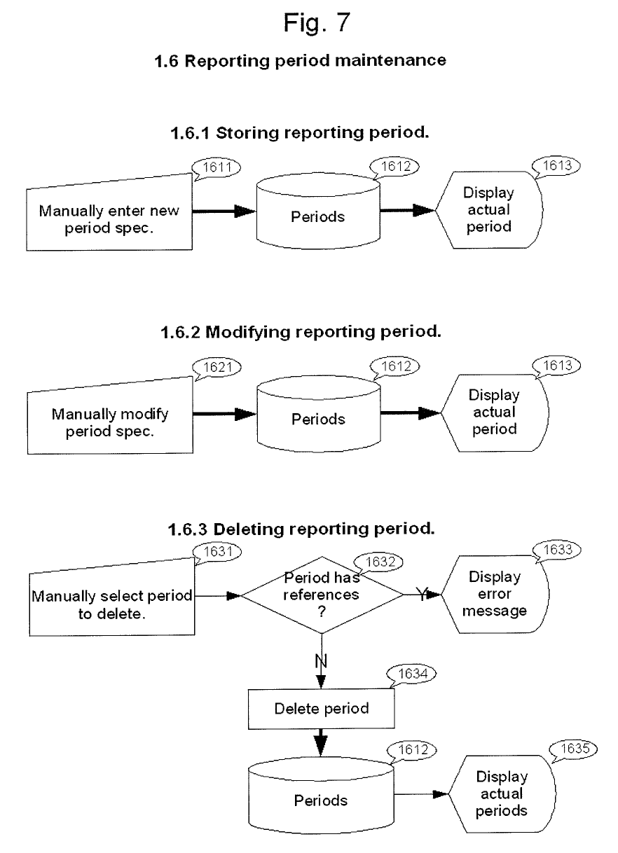

The invention will now be described with reference to FIGS. 1 to 14.

FIG. 1 shows the main functions of the data processing system. The functions can be started via menu block 1.0. The functions that can be initiated are represented by function blocks. The system enables data type and data subtypes to be inputted, stored and maintained via blocks 1.1 and 1.2. Block 1.3 enables the model state to be inputted stored and maintained whilst block 1.4 enables the evaluation types to be inputted, stored and maintained. Block 1.5 enables the location of each data subtype to be inputted stored and maintained and block 1.6 enables the reporting period to be inputted, stored and maintained

The inputted and stored data is used to produce a data map and various versions of the data map may be stored and maintained via block 2.1. Block 2.2 enables the reference values to be inputted, stored and maintained whilst block 2.3 and 2.4 enables model and data volume eminence respectively. Block 3.1 enables the calculation of the data value and block 4.1 allows for the values to be posted to the general ledger. Finally blocks 5.1 and 5.2 enable the production of a detailed model version report and a general ledger post report.

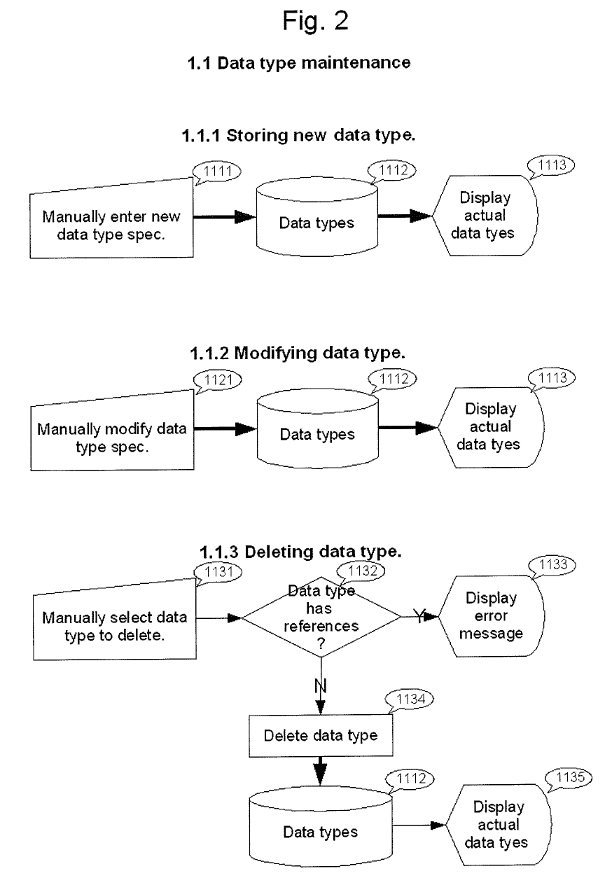

FIGS. 2 to 7 show the procedure for maintenance of the data type, data subtype, model state, evaluation type, location and reporting period maintenance. The procedure allows for inputting, storing and displaying data. The procedure also allows for the modification and the deletion of the data.

The data type is typically provided with a part identifier, name and description, e.g., PERSON, CUSTOMER, PRODUCT, BUILDNG, etc. The data subtype is identified together by the identifier of the basic data type and the own part identifier of the data subtype e.g. PERSON/1, PERSON/2.

The system can store various model versions of the data map and the respective model state. Three basic model states are possible i.e. plan, current and out of date. The current state represents a model that is currently valid. The out of date state defines a model that was current at some time in the past but which has lost its current status because of subsequent modifications. The plan state defines a model which may be realized at some time in the future. Each model state is provided with an identifier e.g. ACURR@, AOLD@ and APLAN@.

The reference value can be evaluated based on several evaluation types. The features of an evaluation type include an identifier and a description of the evaluation type. The evaluation type is either quantity dependent or quantity independent and also has a calculation type attribute.

The location of each data subtype is entered into the system. The locations can be various real estates, folders, computers or databases. The features of the locations include an identifier, a name and a description e.g. ADATABASE7@ and ARECORDS1@. Typically the data can be evaluated over a particular period and evaluations can be delivered to the general ledger by each period. Consequently the period of evaluation may be entered into the system. The features of the period include an identifier, a year and a month.

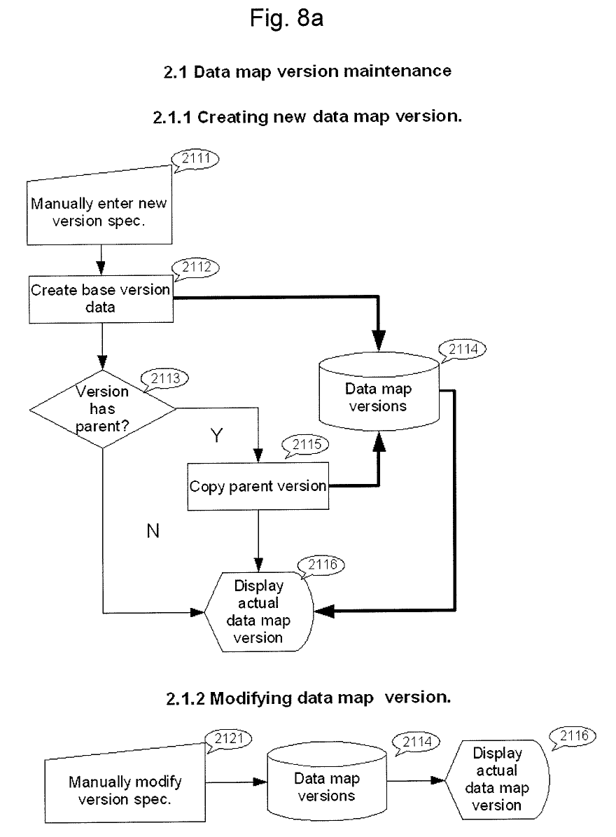

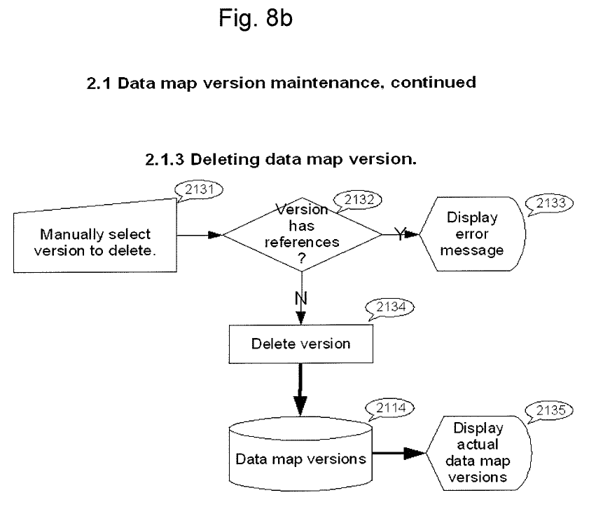

FIGS. 8a and 8b shows the data map version maintenance. A new data map version may be entered into the system via step 2111. The features of the new data map version may include a version number, the status of the new version and the parent version of the new version (selected from among the already existing versions). Optionally the new data map version may include a text label and a text remark. After the entry of the features, step 2112 stores the data map version in data store no. 2114. Step 2113 checks whether the new data map version has a parent version. If it does not then the procedure is continued via step 2116 which displays the new data map version. If the new data map version has a parent version, then step 2115 copies the features of the parent version to the new version and stores them in data store 2114. Then the procedure is continued by step 2116. Procedure 2.1.2 allows the user to modify each feature of the data map version. In step 2121 the user selects the data map version to be modified and can enter the features to be modified. The procedure stores the modified features in data store 2114 then displays the current features of the data map in step 2116.

Procedure 2.1.3. deletes a data map version. In step 2131 the user selects the data map version to be deleted. If deletion is prohibited the procedure is continued by step 2133, which displays an error message. If deletion is not prohibited the process continues with step 2134, which deletes the data map version from data store 2114. The procedure is then continued by step 2135 which displays the list of data map versions.

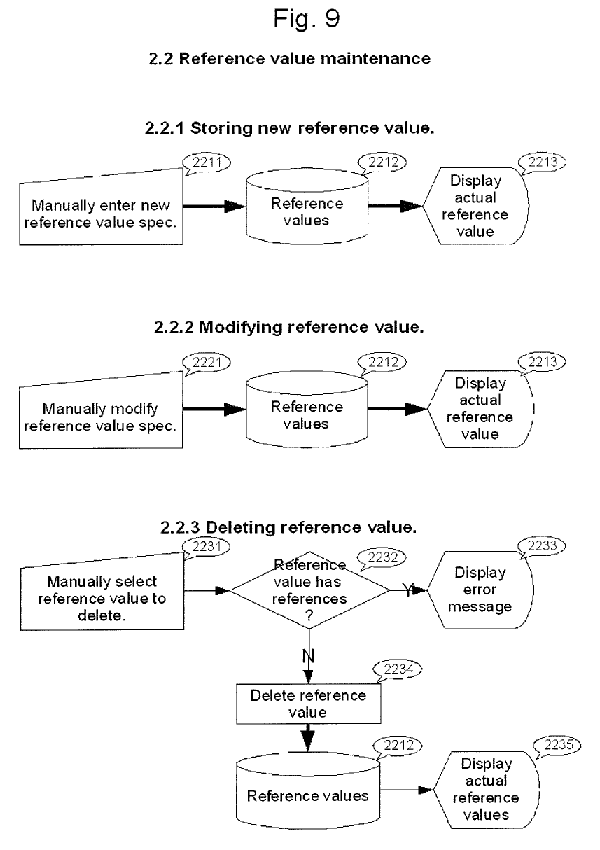

FIG. 9 shows the maintenance of reference values. The data maps include various reference values assigned to each data subtype occurrence. Procedure 2.2.1 stores a new reference value. After the entry of the reference value, the procedure stores the data in data store 2212 then displays the current reference value data in step 2213. Procedure 2.2.2 modifies the features of the reference value and Step 2221 allows the user to modify the reference values. The system then stores the reference value in data store no. 2212 which can be displayed via step 2213.

Procedure 2.2.3 allows for the deletion of a reference value. In step 2231 the user selects the reference value to be deleted. Then the procedure checks via step 2232 the reference value to be deleted. If deletion is prohibited the procedure displays an error message in step 2233 and if deletion is not prohibited step no. 2234 deletes the reference value from data store 2212. The procedure is then continued by step 2235 which displays the current reference values.

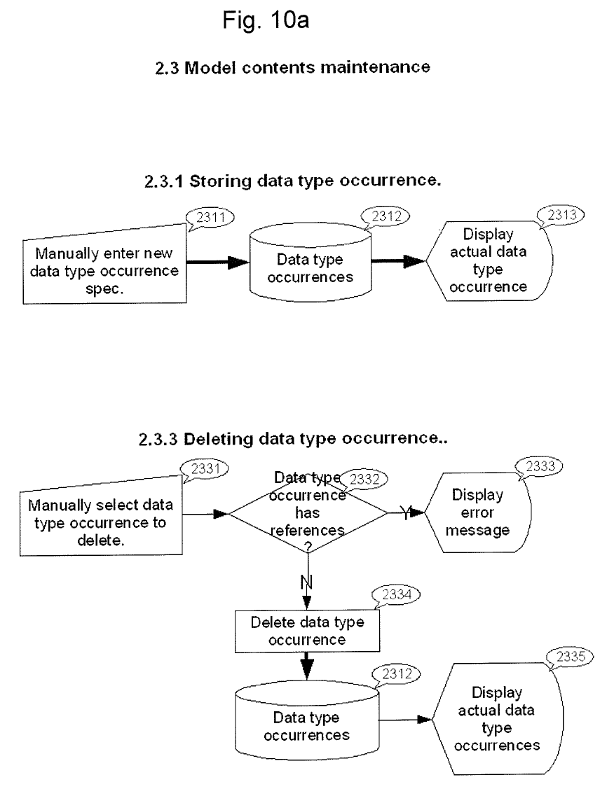

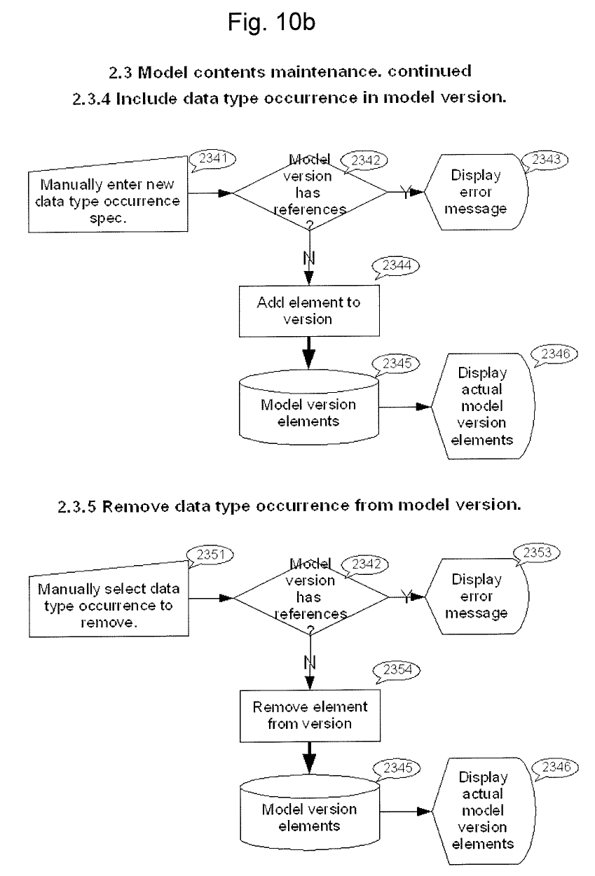

FIGS. 10a and 10b show the maintenance of the content of model versions. A model version comprises data subtypes occurrences listed within a data map version. The maintenance of model versions requires updating occurrence of data subtypes and inputting the occurrences to the appropriate data map version.

Procedure 2.3.1 stores a new data subtype occurrence and step 2311 allows the user to enter the new features of the data subtype occurrence. The features of the data subtype occurrence include the serial number of the occurrence, a location and a weighting.

After the entry of the features of the data subtype occurrence, the procedure stores the data in data store 2312 then displays the current data subtype occurrence in step 2313.

Procedure 2.3.3 allows for the deletion of a data subtype occurrence. In step 2331 the user selects the data subtype occurrence to be deleted. Then the procedure checks in step 2332 the data subtype occurrence to be deleted. If deletion is prohibited the procedure displays an error message in step 2333. If deletion is not prohibited step no. 2334 deletes the data subtype occurrence from data store 2312. The procedure is then continued via step 2335 which displays the current data subtype occurrences.

Procedure 2.3.4 inputs a data subtype occurrence to the model version. Step 2341 allows the user to select the data subtype occurrence and the model version. Then step 2342 checks whether a ledger delivery refers to the selected model version. If yes, no new elements can be entered into the version and step 2343 displays an error message. If no, step 2344 stores the data in data store 2342, and displays the current content via step 2346.

Procedure 2.3.5 eliminates one element of a model version. In step 2351 the user selects the model version element to be eliminated. Step 2342 checks whether a ledger delivery refers to the selected element of the model version. If yes, the element cannot be deleted from the version and step 2353 displays an error message. If no, step 2354 deletes the data from data store 2342 and displays the current content of the model version in step 2343.

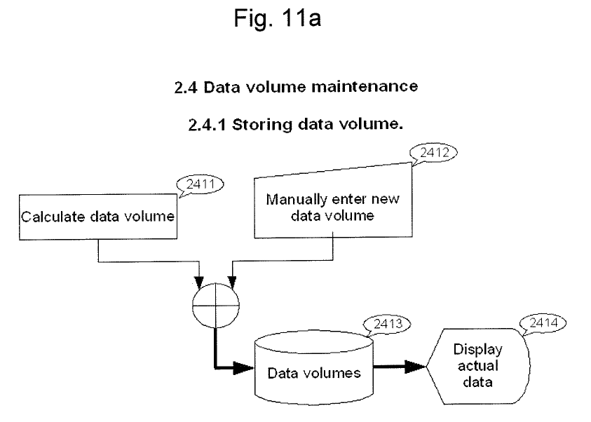

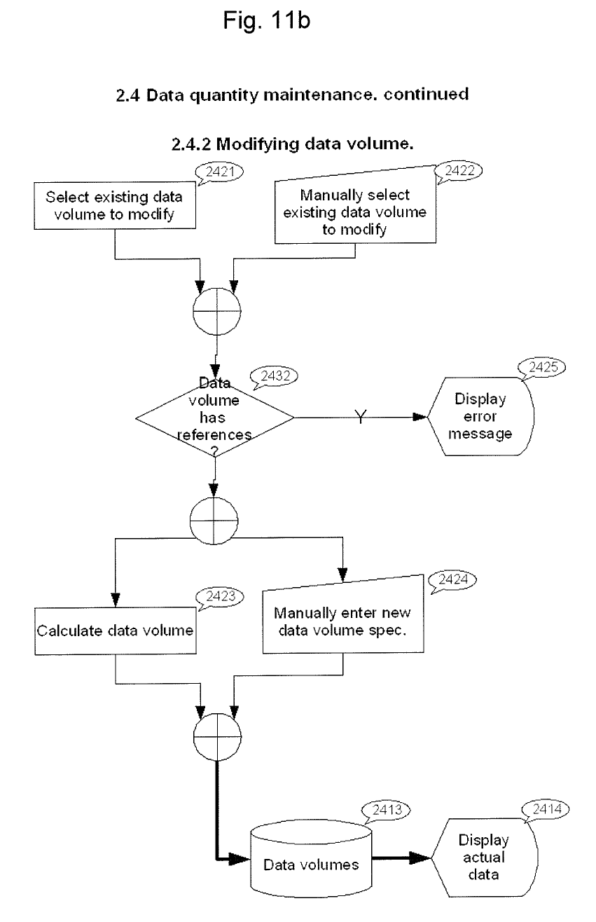

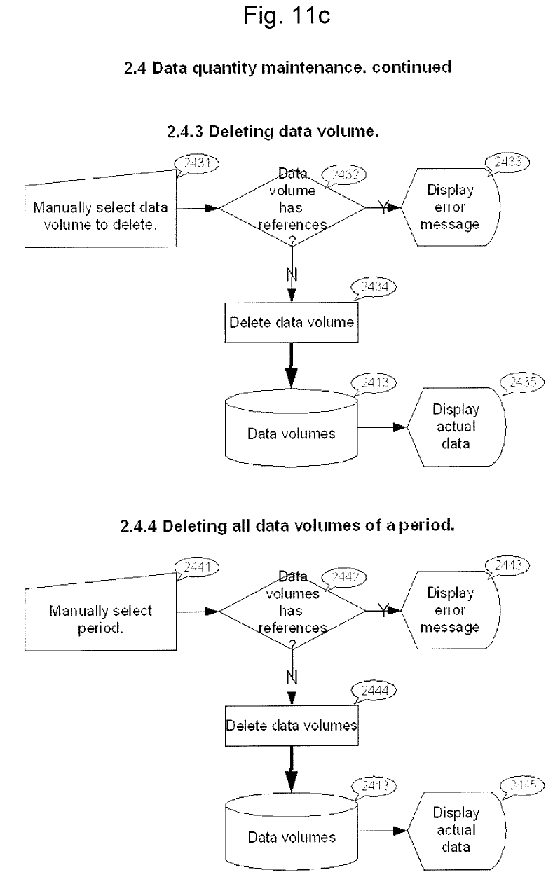

FIGS. 11a, 11b and 11c show the maintenance of data quantities. In order to evaluate the corporate data the quantity of data must be defined. Procedure 2.4.1 stores a new data volume. If the data is recorded automatically, step 2411 defines the data volume, and if manual recording is employed, step 2412 allows the user to input the data volume. The features of the data volume include the data subtype occurrence, the current period and the quantity of data.

After the definition of the features, the system stores the new data volume in data store no. 2413. If the entry was manual step 2414 displays the current data volume. Procedure no. 2.4.2 modifies a data volume. If the entry was automatic, the procedure initiating the operation selects the data volume to be modified in step 2421 and the data subtype occurrence and the period must be entered. If the modification is manual the user selects the data type occurrence and the period via step 2422.

Step 2432 checks whether the data volume can be modified. If the data volume cannot be modified the procedure displays an error message in step 2425. If modification is allowed, in the case of automatic modification, step no. 2423 defines the current volume of the selected data subtype occurrence. If the modification is manual, the user enters the volume in step 2424. Then the procedure modifies the data volume in data store 2413 and displays the current data volume in step 2414.

Procedure 2.4.3 deletes a data volume. A data volume can only be deleted manually. In step 2431 the user selects the data volume to be deleted. If the data volume cannot be deleted and the procedure displays an error message in step 2433. If the data volume can be deleted step no. 2434 deletes the selected data volume from data store 2413 and step 2435 displays the current data volume.

Procedure 2.4.4 deletes all the data volumes of a period. In step 2441 the user selects the period and the data volumes of which the user wishes to delete. Step 2442 checks if the data volumes can be deleted. If not, the period cannot be deleted and the procedure displays an error message in step 2443. If the data volumes can be deleted step no. 2444 deletes the data volumes from data store 2413. Finally step 2445 displays the list of current data volumes.

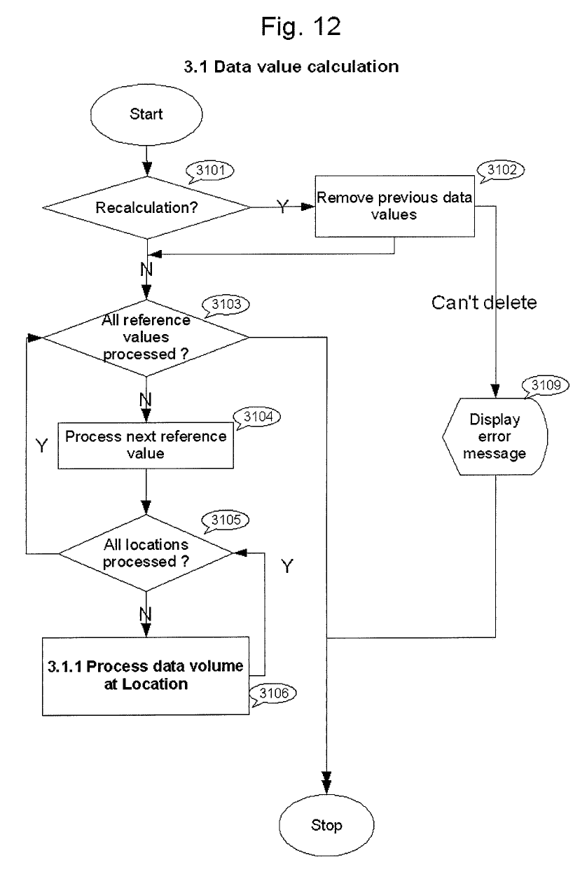

FIG. 12 shows the calculation of the value of the data. Based on the data assets inventory the value of the data can be calculated. Procedure 3.1 calculates the value of the data. Step 3101 establishes whether the calculation is a recalculation. If yes, step 3102 deletes the result of the previous calculation. If deletion is not possible because it already refers to a data value that has been nominated for ledger delivery, the procedure sends an error message via step 3109.

If there is no recalculation or if the deletion of previous data was successful the procedure continues with step 3103. This step checks whether the data value calculation has been completed with all the reference values. If yes, the procedure is terminated. If no, the procedure is continued with step 3104 processing of the next reference value.

Step 3105 checks whether all the locations have been processed. If yes, the procedure returns to step 3103. If no, the procedure is continued with procedure 3.1.1, which performs the calculation.

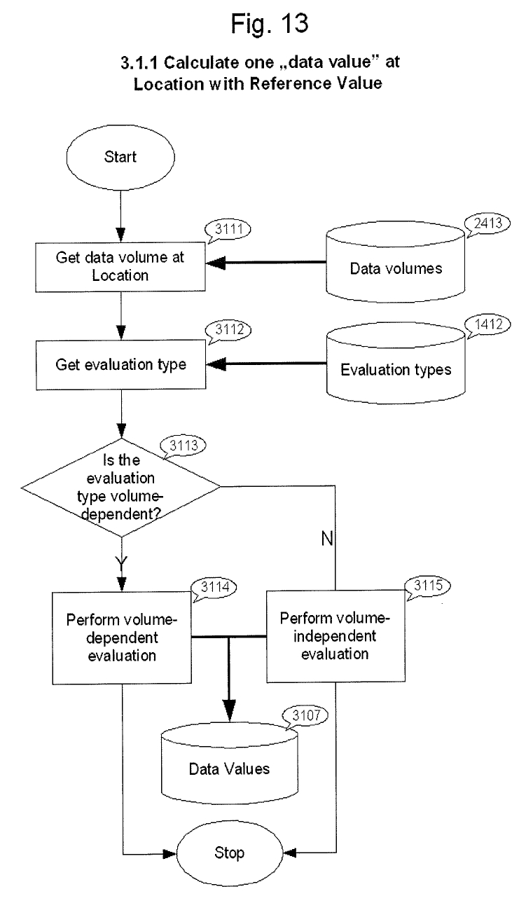

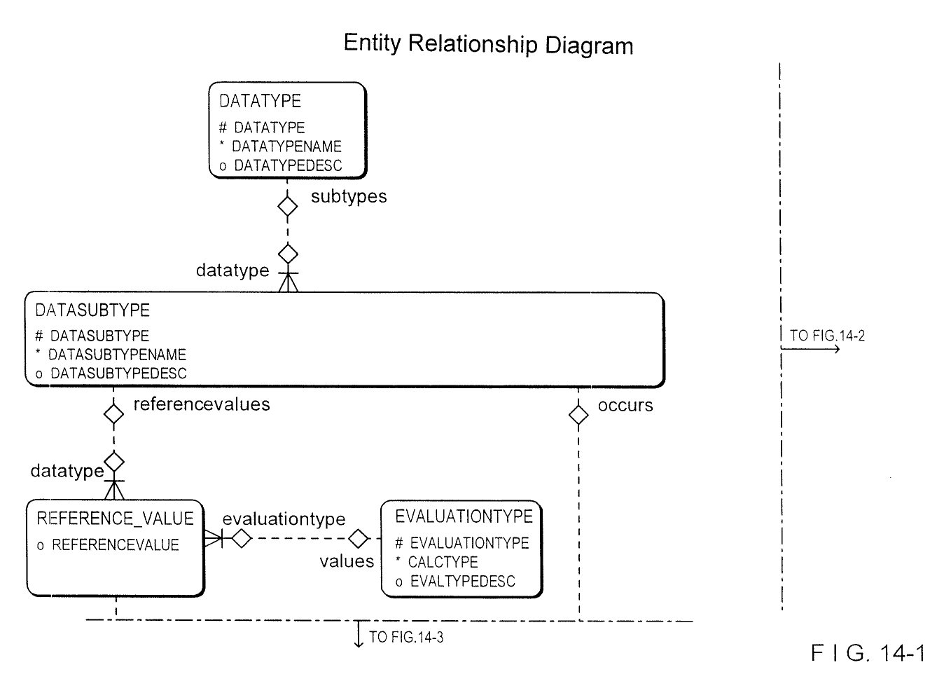

FIG. 13 shows the calculation of a data value at one location based on a given reference value. Procedure 3.1.1 calculates the current data value of a data type. The value is calculated at one location based on the defined reference value. The calculated value is stored as the value of the current reporting period.

Initially step no. 3111 defines the quantity of data belonging to the data type. Then step 3112 reads the evaluation type and step 3113 establishes whether the evaluation type depends on the data quantity or whether it is independent of it. Finally the data values are calculated via step 3114 or step 3115. The calculated data value is stored by the procedure in data store no. 3107.

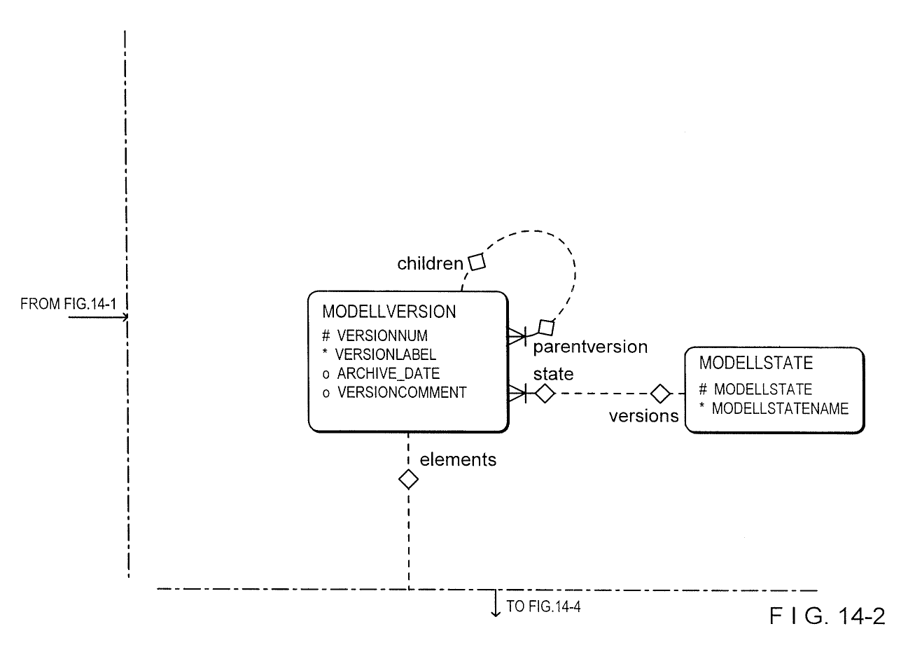

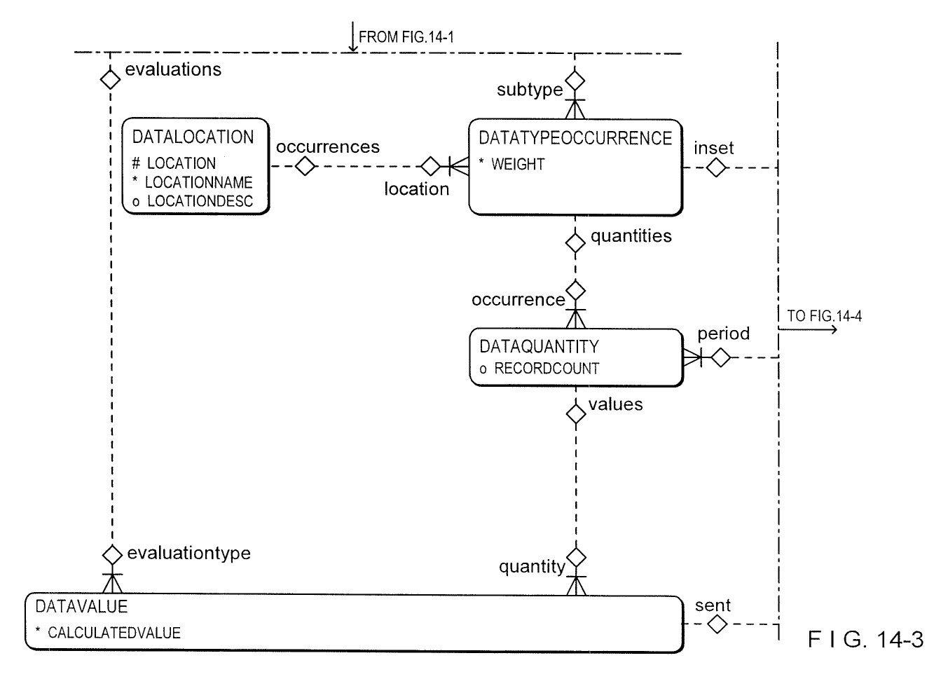

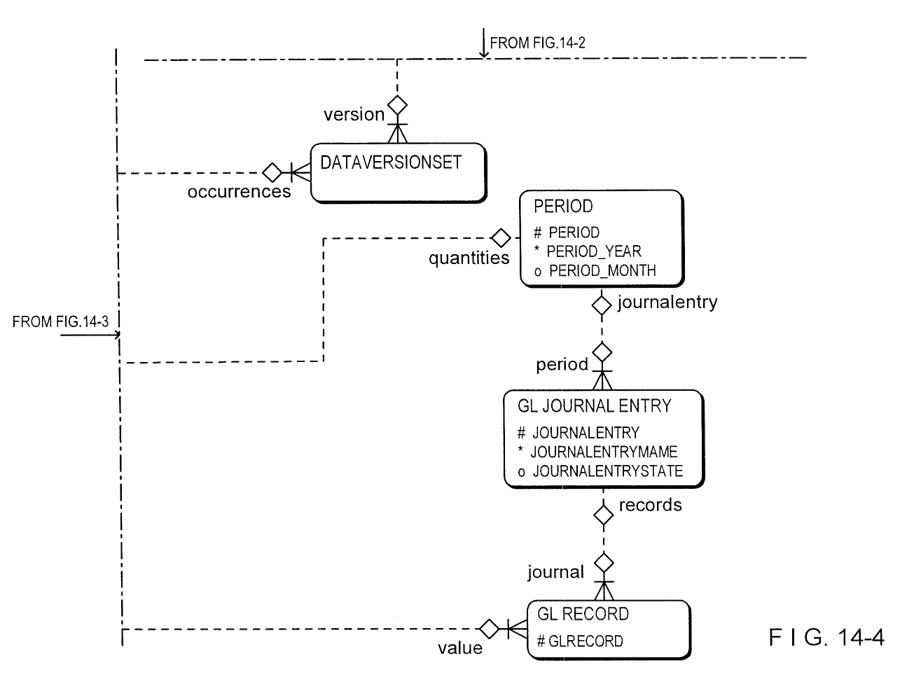

FIG. 14 shows a data model of the data map, the data assets inventory and their connection to the general ledger and illustrates the abovementioned function blocks and their relationship with each other.

The invention will now be illustrated in the following examples.

### EXAMPLE 1

The following example shows a moderately disintegrated IT system. The corporate IT strategy is taken as integration consequently the appropriate assessment method is supporting integration.

Initially a data map is prepared.

The data types and the subtypes are recorded.

| Data types | Data subtypes |
|---|---|
| Partners | Customers |
| | Customers in the old IT system |
| | Suppliers |
| Products | Axes |
| | Shovels |
| | Interplanetary starships |
| Payments | Purchase |
| | Rentals |

The locations of the data types and the subtypes are then recorded

| Location | Description |
|---|---|
| DBNew | New business IT system database at Businesshost. |
| DBOld | Old business IT system database at Businesshost. |

Finally the data subtypes occurrences are recorded to provide a data map.

| Data Subtype | Location |
|---|---|
| Customers | DBNew |
| Customers in the old IT system | DBOld |
| Suppliers | DBNew |
| Axes | DBOld |
| Axes | DBNew |
| Shovels | DBOld |
| Shovels | DBNew |
| Interplanetary starships | DBNew |
| Purchase | DBOld |
| Purchase | DBNew |
| Rentals | DBNew |

A weighting is then assigned to each data subtype occurrence to provide a data assets inventory. Initially each data subtype occurrence is given a weighting to reflect the visible disintegration.

| Data Subtype | Location | Weight |
|---|---|---|
| Customers | DBNew | 0.3 |
| Customers in the old IT system | DBOld | 0.3 |
| Suppliers | DBNew | 0.3 |
| Axes | DBOld | 0.4 |
| Axes | DBNew | 0.4 |
| Shovels | DBOld | 0.4 |
| Shovels | DBNew | 0.4 |
| Interplanetary starships | DBNew | 1 |
| Purchase | DBOld | 0.4 |
| Purchase | DBNew | 0.4 |
| Rentals | DBNew | 1 |

The assessment method is chosen as supporting integration, and the evaluation type is quantity independent. A reference value is then linked to the data subtype occurrence. This step typically employs local expertise. The reference value is influenced by many factors, known only by the local experts.

| Data types | Data subtypes | Reference value | |
|---|---|---|---|
| Partners | Customers | 10 000,00 | USD |
| | Customers in the old IT system | 9 000,00 | USD |
| | Suppliers | 11 000,00 | USD |
| Products | Axes | 1 000,00 | USD |
| | Shovels | 1 000,00 | USD |
| | Interplanetary starships | 50 000,00 | USD |
| Payments | Purchase | 500,00 | USD |
| | Rentals | 1 000,00 | USD |

The next step is the data value calculation. This provides a data assets inventory with a particular total value.

Value=Sum(Reference Valueₙ*Weighting)

| Reference Valuen | Weighting | Comment |
|---|---|---|
| 10 000,00 USD | 0.3 | (Customers at DBNew) |
| 9 000,00 USD | 0.3 | (Customers in the old IT system |
| | | at DBOld) |
| 11 000,00 USD | 0.3 | (Suppliers at DBNew) |
| 1 000,00 USD | 0.4 | (Axes at DBOld) |
| 1 000,00 USD | 0.4 | (Axes at DBNew) |
| 1 000,00 USD | 0.4 | (Shovels at DBOld) |
| 1 000,00 USD | 0.4 | (Shovels at DBNew) |
| 50 000,00 USD | 1 | (Interplanetary starships at DBNew) |
| 500,00 USD | 0.4 | (Purchase at DBOld) |
| 500,00 USD | 0.4 | (Purchase at DBNew) |
| 1 000,00 USD | 1 | (Rentals at DBNew) |

| | |
|---|---|
| 62 000,00 USD | Sum |

The assessed data value is 62000 USD.

After assessing the value of the data assets inventory various modifications can be made and it can be seen how these would effect the total value.

Version 1

The first version creates a new IT subsystem to store and manage all the subtypes of the “Partners” data type, at one “Location”. This is done by creating a new data subtype called “All Partners”. This data subtype is a general one, containing the “Customers” and “Suppliers” data. The “Customers” data at dbold and dbnew, and “Suppliers” are synchronized with the new “Partners” database.

The new data subtype:

| | Data | |
|---|---|---|
| Data types | subtypes | Change |
| Partners | | |
| | All Partners | New |

The new Location:

| Location | Description | Change |
|---|---|---|
| Dbcust | The master “Partners” database. | New |

The new data subtype occurrence:

| Data Subtype | Location | Change |
|---|---|---|
| All Partners | Dbcust | New |

Reference values:

| Data types | Data subtypes | Reference value | Change |
|---|---|---|---|
| Partners | | | |
| | All Partners | 28 000,00 USD | New |

The new reference value is lower than the value of the sum of the old data subtypes values. This is because the consolidated data will contain duplicates and the local experts lower the reference value accordingly.

The new and changed data subtype occurrence weighting are then assigned.

| Data subtype | Location | Weight | Change |
|---|---|---|---|
| Customers | Dbnew | 0.00 | Decreased to 0.00, because this |
| | | | data is part of “All Partners”. |
| Customers in the | Dbold | 0.00 | Decreased to 0.00, because this |
| old IT system | | | data is part of “All Partners”. |
| Suppliers | Dbnew | 0.00 | Decreased to 0.00, because this |
| | | | data is part of “All Partners”. |
| All Partners | Dbcust | 1.00 | New |

The change in the weighting indicates that the old data has lost all of its significance.

The next step is the data value calculation wherein the Value=Sum(Reference Valuen*Weighting)

| Reference | | | |
|---|---|---|---|
| Valuen | Weighting | Comment | Change |
| 1 000,00 USD | 0 | (Customers at dbnew) | Changed |
| 9 000,00 USD | 0 | (Customers in the old IT | Changed |
| | | system at dbold) | |
| 11 000,00 USD | 0 | (Suppliers at dbnew) | Changed |
| 1 000,00 USD | 0.4 | (Axes at dbold) | |
| 1 000,00 USD | 0.4 | (Axes at dbnew) | |
| 1 000,00 USD | 0.4 | (Shovels at dbold) | |
| 1 000,00 USD | 0.4 | (Shovels at dbnew) | |
| 50 000,00 USD | 1 | (Interplanetary starships at | |
| | | dbnew) | |
| 500,00 USD | 0.4 | (Purchase at dbold) | |
| 500,00 USD | 0.4 | (Purchase at dbnew) | |
| 1 000,00 USD | 1 | (Rentals at dbnew) | |

| | |
|---|---|
| 81 000,00 USD | Sum |

Version 2

The second version involves moving the “Purchase” data from the old database to the new. The changes are shown below.

Data subtype occurrence:

| Data subtype | Location | Change |
|---|---|---|
| Purchase | Dbold | Delete |

Data Occurrence weight:

| Data subtype | Location | Weight | Change |
|---|---|---|---|
| Purchase | Dbnew | 1.00 | Changed |

The new value of the corporate data assets Value=Sum(Reference Valuen*Weighting)

| Reference Valuen | Weighting | Comment |
|---|---|---|
| 10 000,00 USD | 0.30 | (Customers at dbnew) |
| 9 000,00 USD | 0.30 | (Customers in the old IT system at |
| | | dbold) |
| 11 000,00 USD | 0.30 | (Suppliers at dbnew) |
| 1 000,00 USD | 0.40 | (Axes at dbold) |
| 1 000,00 USD | 0.40 | (Axes at dbnew) |
| 1 000,00 USD | 0.40 | (Shovels at dbold) |
| 1 000,00 USD | 0.40 | (Shovels at dbnew) |
| 50 000,00 USD | 1.00 | (Interplanetary starships at dbnew) |
| 500,00 USD | 1.00 | (Purchase at dbnew) |
| 1 000,00 USD | 1.00 | (Rentals at dbnew) |

| | |
|---|---|
| 62 100,00 USD | Sum |

It can be seen that the second version makes minimal impact on the value of the data assets inventory while the first version exhibits a significant improvement. Consequently these changes in the value of data assets inventory with the development costs and other factors can assist in improving corporate IT management.

### EXAMPLE 2

The following examples illustrate how data can be evaluated by employing different evaluation types.

The data types and subtypes are recorded

Data types/Data subtypes

Person/Customer

The evaluation type is then selected

| Evaluation types | Calculation type |
|---|---|
| Monetary | Quantity dependent |
| IT technical | Quantity independent |
| Security stake | Quantity independent |

The reference value is assigned

Reference values

| Data type/Data subtype | Evaluation type | Reference value |
|---|---|---|
| Person/Customer | Monetary | 10 |
| Person/Customer | IT technical | 10000 |
| Person/Customer | Security stake | 20000 |

The locations are then recorded and a weighting is assigned to the data type occurrence.

Data type occurrences

| Data type/Data subtype | Location | Weighting |
|---|---|---|
| Person/Customer | Main database | 1.0 |

The data quantity is recorded.

Data quantity

| | | Period (When | |
|---|---|---|---|
| | | the quantity has | Quantity |
| Location | Data type/Data subtype | been counted?) | (record count) |
| Main | Person/Customer | 2007Q3 | 1000 |
| database | | | |

The value of the data can now be calculated using the different evaluation types which can be conducted simultaneously.

Monetary type evaluation, for e.g. facilitating business decisions.

Reference Value=10Weighting=1quantity value=1000

The evaluation type is monetary and quantity dependent.

Consequently the monetary value of the data is 10*1*1000

IT technical type evaluation, for e.g. for facilitating technical decisions and proposals

Reference Value=10000Weighting

The evaluation type is IT technical evaluation type and quantity independent.

Consequently the IT technical value of the data is 10000*1

The unit of the IT technical value will be decided locally by IT experts and this is given an abstract point value which may be based on technical excellence.

Security stake type evaluation, for e.g. estimating the security stakes

Reference Value=20000 Weight=1

The evaluation type is security stake evaluation and quantity independent.

Consequently the Security stake value of the data is 20000*1

The unit of the security stake value will be decided locally be security experts and this is typically given an abstract point value which may be based on security risk but may also be given a monetary value based on a potential security breach.

1. Accordingly, the present invention provides a method of assessing the data value of a data assets inventory which comprises:
a) preparing a data map on a computer database comprising inputting data types and data subtypes into said database, connecting a data storing location to the data subtypes and recording the data subtype occurrences in said database;
b) assigning a weighting to each data subtype occurrence in said database to provide a data assets inventory and recording the data assets inventory in said database;
c) preparing evaluation types on said database wherein the evaluation type has a calculation type attribute and wherein the evaluation type is either quantity independent or quantity dependent;
d) connecting at least one evaluation type to each data subtype with a reference value and recording the reference value in said database;
e) determining the data value of the data assets inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value for each data subtype occurrence.

2. A method according to claim 1, wherein the data types are selected from the group consisting of Clients, Suppliers, Goods, Materials, Warehouses, Partners, Contracts, Financial Movements and Assets.

3. A method according to claim 1, wherein the data subtypes are selected from the group consisting of Partner-Person, Partner-Supplier, Partner-Lawyer ContractBSupply contract, Contract-Agent contract, Financial movement B Advance payment, Financial movement-Bills, and Financial Movement-Commission.

4. A method according to claim 1, wherein the data storing location is selected from the group consisting of a folder on a hard disk, a database, a CD rom and a filing cabinet.

5. A method according to claim 1, wherein the evaluation type is a monetary evaluation.

6. A method according to claim 5, wherein the reference value is a monetary value.

7. A method according to claim 1, wherein the evaluation type is quantity dependent.

8. A method according to claim 1, wherein the evaluation type is quantity independent.

9. A method of improving corporate information technology management comprising;
a) preparing a first data map on a computer database comprising inputting data types and data subtypes into said database, connecting a data storing location to the data subtypes and recording the data subtype occurrences in said database;
b) assigning a weighting to each data subtype occurrence in said database to provide a first data assets inventory and recording the first data assets inventory in said database;
c) preparing evaluation types on said database wherein the evaluation type has a calculation type attribute and wherein the evaluation type is either quantity independent or quantity dependent;
d) connecting at least one evaluation type to each data subtype with a reference value and recording the reference value in said database;
e) determining the data value of the first data asset inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value for each data subtype occurrence;
f) changing at least one of the data types, data subtypes, the reference value, the evaluation type, the calculation type, and the weighting in said database;
g) preparing a second data map on said database comprising inputting the data types and data subtypes into said database, connecting a data storing location to the data subtypes and recording the data subtype occurrences in said database.
h) assigning a weighting to each data subtype occurrence in said database to provide a second data assets inventory and recording the second data assets inventory in said database;
i) preparing evaluation types on said database wherein the evaluation type has a calculation type attribute and wherein the evaluation type is either quantity independent or quantity dependent;
j) connecting at least one evaluation type to each data subtype with a reference value and recording the reference value in said database;
k) determining the data value of the second data assets inventory and recording the data value in said database wherein when the evaluation type is quantity dependent then the value is the product of the weighting, the reference value and the quantity at the data storing location for each data subtype occurrence or wherein when the evaluation type is quantity independent then the value is the product of the weighting and the reference value of each data subtype occurrence;
l) comparing the total value of the first data assets inventory with the second data assets inventory to obtain a value differential, and;
m) using said value differential to improve corporate information technology management.

10. A method according to claim 1, wherein the data types are selected from the group consisting of Clients, Suppliers, Goods, Materials, Warehouses, Partners, Contracts, Financial Movements and Assets.

11. A method according to claim 1, wherein the data subtypes are selected from the group consisting of Partner-Person, Partner-Supplier, Partner-Lawyer ContractBSupply contract, Contract-Agent contract, Financial movement B Advance payment, Financial movement-Bills, and Financial Movement-Commission.

12. A method according to claim 1, wherein the data storing location is selected from the group consisting of a folder on a hard disk, a database, a CD rom and a filing cabinet.

13. A method according to claim 1, wherein the evaluation type is a monetary evaluation.

14. A method according to claim 5, wherein the reference value is a monetary value.

15. A method according to claim 1, wherein the evaluation type is quantity dependent.

16. A method according to claim 1, wherein the evaluation type is quantity independent.

17. A data processing system for producing a data assets inventory and calculating the data value comprising a computer processor means for processing data, a storage means for storing data on a storage medium, means for inputting and storing data types and data subtypes on the storage medium, means for assigning a data storing location to a data subtype and recording the data subtype occurrences to provide a data map, means for storing the data map on the storage medium, means for assigning a weighting to each data sub type occurrence to provide a data assets inventory, means for storing the data assets inventory on the storage medium, means for inputting evaluation types on the storage medium wherein the evaluation type has a calculation type attribute, means for connecting at least one evaluation type to each data subtype with a reference value, means for determining the data value of the data assets inventory and means for storing the data value on the storage medium.

18. A data processing system for providing a value differential that can be used to improve corporate information technology management comprising a computer processor means for processing data, a storage means for storing data on a storage medium, means for inputting and storing data types and data subtypes on the storage medium, means for assigning a data storing location to a data subtype and recording the data subtype occurrences to provide a data map, means for storing the data map on the storage medium, means for assigning a weighting to each data subtype occurrence to provide a data assets inventory, means for storing the data assets inventory on the storage medium, means for inputting evaluation types on the storage medium wherein the evaluation type has a calculation type attribute, means for connecting at least one evaluation type to each data subtype with a reference value, means for determining a first data value of the data assets inventory, means for storing the first data value on the storage medium, means for modifying the data by changing at least one of the group consisting of data types, data subtypes, the reference value, the evaluation type, the calculation type, and the weighting, a means for determining a second data value of the data assets inventory, means for storing the second data value on the storage medium, a means for comparing the first data value and the second data value to obtain a value differential and a means for storing said value differential on the storage medium.
